(19) United States
(12) Patent Application Publication
(10) Pub. No.: US 2007/0218973 A1
(43) Pub. Date: Sep. 20, 2007

(54) SALES METHOD FOR LUXURY GOODS

(76) Inventor: Carlos DIAS, Carouge (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/687,851

(22) Filed: Mar. 19, 2007

Related U.S. Application Data
(60) Provisional application No. 60/783,388, filed on Mar. 20, 2006.

(51) Int. Cl. A63F 13/00

(52) U.S. Cl. 463/20

(57) ABSTRACT

The invention is a sales method of luxury goods through slot machines, in which the potential buyer inserts a sum into the machine, starts it up and waits for it to stop. He wins the goods he desires if the pre programmed winning combination appears on the machine.

The current invention concerns a sales method of luxury goods using slot machines.

Everybody knows of games of chance and other lotteries, which are diverse and varied depending on the country that allows them, and the declared aim is to win a sometimes large amount of money after betting a relatively small sum. Some, called tombola or a raffle allow you to win a prize in the form of goods drawn by lots. Everyone knows bingo, where the aim is to obtain a full line of numbers that have been drawn by chance and to win a prize under the form of goods, once the sufficient amount of numbers have been reached on one line printed on the card that can have more than one line of numbers.

No game of chance has the aim of selling goods, not to mention the sale of luxury goods, the form of goods the prize can take is generally of low cost items and often they have been given to the organizers in the form of a charity fair.

Everybody knows the games of chance in the shape of slot machines that can be often found, depending on the country's legislation, in public places like café's or grouped together in an establishment dedicated to that type of machine, these are better know as casinos or game arcades etc. or all other similar types of establishments, that we shall refer to as casinos for the rest of this document. The idea is for the user to bet via the slot machine and depending on the result coming out of the machine, a sum of money that can either cover the initial bet or be a substantial amount gained, and could be the top amount commonly known as “jackpot”, which is generally marked by as sound flashing lights that is intended to trigger the player's enthusiasm and exaltation, and creating a sense of envy and desire to keep on playing for the neighbouring players.

None of the previous stated methods aims are to in the end sell goods, but only to satiate a player's need for gambling.

On the contrary, the present invention has a clear aim and goal to sell luxury products, it is true in a fun way, but in which the aspect of the game is just a pretext. It allows the lucky buyer, through the effect of multiple chance and probabilities, to acquire luxury goods that can be very expensive were as the sum that was used to bet with is so much smaller than the value of the goods in question. The buyer can therefore hope to obtain an item he could never have laid pretence for through a classic sales method. It therefore opens up a whole new perspective for the sales of luxury goods.

The invention therefore concerns a sales method or distribution of luxury goods using slot machines, where the users inserts a certain amount, launches the machine and waits for it to stop, the luxury goods the user hopes for are acquired if the machine comes up with a pre-programmed winning combination

As we all know, slot machines can be activated by a button or a lever on the side, or simply by inserting the amount, a token or a coin into a slot, a sensor validates the entry sending an activation signal to the machines mechanism. The buyer can then intervene or remain passive.

The method can be easily put into practice with window slot machines that generally have a line of windows, between three and six windows, sometimes more. When the machine stops, a combination of symbols appear in the windows.

Of course, the inserted amount is proportional to the value of the goods desired, also taking into account the number of windows and the sums of statistical probabilities defining how the machine is configured.

As mentioned previously, the goods available for sale are luxury goods, particularly chosen from precious stones, precious metals, jewelry, perfume, and expensive watches, luxury clothes and leather good, expensive cars as well as boats and planes, and any other luxury goods.

Preferably, the symbols in the windows are illustrations full-size or scaled down of the goods available through that particular machine. For example, there's a machine for watches, which has photographs in the symbol windows of the watches available.

A first variation, the machine only allows the acquisition of the luxury goods if the windows display the symbols of the desired goods. This machine functions along the principle of a unique prize and one can imagine quite easily that the principle can be applied to luxury goods such as a car or a boat.

A second variation, the machine allows the multiple combination wins, in particular the imperfect combination which allow you to win a consolation prize, if not all the windows display the correct full winning combination of the desired goods, for example five out of six. According to the symbols displayed in the remaining windows, with or without a joker, or with a succession more or less regular of the desired goods, the buyer shall receive the desired goods but not the luxury type.

The principle of multiple prizes applies perfectly to the retail of watches for example, where the main prize would be a solid gold watch. And the consolation prize would be a model with a leather wrist strap, or a titanium model, or a stainless steel model etc, depending on the imperfect combination obtained.

In a first embodiment, the slot machines shall be installed in a casino, and the company running the casino shall have before hand bought the luxury goods that can be won.

In another embodiment, the slot machines shall be to install the slot machines in a facility where half of the room space is like a games room, and the other half would be a traditional boutique. The buyer can as he desires, go from one part to the other according the his likes and dislikes.

It must be pointed out, that the casino mentioned here as well as the boutique that goes with it can be set up on land, in a country that has the appropriate legislation.

It could also be set up on board a ship, especially cruise ships where passengers have plenty of free time.

Another possible set up could be on board a long haul flight, where a passenger looks for things to do to pass the time.

It is interesting to observe in the end, that if the casino is run by the company that manufactures the luxury goods that can be won, the sales method then becomes a direct sales method.

1. The sales method of luxury goods using slot machines, wherein the potential buyer inserts a sum into the slot machine, starts the machine and waits for it to stop, obtaining the luxury goods he would like to acquire if pre-programmed winning combination turns up on the machine.

2. The sales method according to claim 1, wherein the slot machine has windows and the winning combinations appear in these windows.

3. The sales method according to claim 1, wherein the amount of the bet depends on the value of the item to be won.

4. The sales method according to claim 1, wherein the luxury goods are selected from the group comprising precious stones and metals, jewelry, perfume, luxury watches, luxury clothes and leather items, luxury cars, boats and jets, or any other luxury product.

5. The sales method according to claim 1, wherein the slot machines are programmed to deliver one or more winning combinations.

6. The sales method according to claim 1, wherein the slot machines are installed in a casino or similar establishment.

7. The sales method according to claim 1, wherein the luxury goods that can be won, have been previously bought by the casino or the company running the facility.

8. The sales method according to claim 1, wherein the slot machines shall be set up in a facility that is partly a casino and the other part is a traditional boutique, the buyers being directed to one part or the other according to his desires.

9. The sales method according to claim 7, wherein the casino, possibly the boutique as well, are set up on land, on board a ship or a plane.

10. The sales method according to claim 7, wherein the casino is run by the manufacturer of the luxury goods that can be won, the sales method then becoming a direct sales method.

11. The sales method according to claim 8, wherein the casino, possibly the boutique as well, are set up on land, on board a ship or a plane.

12. The sales method according to claim 8, wherein the casino is run by the manufacturer of the luxury goods that can be won, the sales method then becoming a direct sales method.

13. The sales method according to claim 9, wherein the casino is run by the manufacturer of the luxury goods that can be won, the sales method then becoming a direct sales method.
